(19) United States
(12) Patent Application Publication
(10) Pub. No.: US 2026/0172848 A1
(43) Pub. Date: Jun. 18, 2026

(54) DIGITAL TWIN ASSISTED POSITIONING

(71) Applicant: QUALCOMM Incorporated, San Diego, CA (US)

(72) Inventors: Mohammed Ali Mohammed HIRZALLAH, San Marcos, CA (US); Xiaoxia ZHANG, San Diego, CA (US); Rajat PRAKASH, San Diego, CA (US)

(21) Appl. No.: 18/983,591

(22) Filed: Dec. 17, 2024

(51) Int. Cl. H04W 16/22; H04W 24/06; H04W 64/00

(52) U.S. Cl. CPC H04W 16/22; H04W 24/06; H04W 64/00

(57) ABSTRACT

A method, of obtaining and using synthetic mobile device positioning model data, includes: transmitting, from a requesting device to an apparatus configured to implement a digital twin function, a positioning model data request indicating at least one characterization parameter for at least one of determining positioning model data and reporting the positioning model data; and receiving, at the requesting device from the apparatus, positioning model data indicating a plurality of reception locations and, for each of the plurality of reception locations, a plurality of sets of clustered synthetic signal information.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

It is often desirable to know the location and/or motion (e.g., speed or velocity) of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

### SUMMARY

An example method, of obtaining and using synthetic mobile device positioning model data, includes: transmitting, from a requesting device to an apparatus configured to implement a digital twin function, a positioning model data request indicating at least one characterization parameter for at least one of determining positioning model data and reporting the positioning model data; and receiving, at the requesting device from the apparatus, positioning model data indicating a plurality of reception locations and, for each of the plurality of reception locations, a plurality of sets of clustered synthetic signal information.

An example positioning model entity includes: at least one transceiver; at least one memory; and at least one processor, communicatively coupled to the at least one transceiver and the at least one memory, configured to: transmit, via the at least one transceiver to an apparatus configured to implement a digital twin function, a positioning model data request indicating at least one characterization parameter for at least one of determining positioning model data and reporting the positioning model data; and receive, via the at least one transceiver from the apparatus, positioning model data indicating a plurality of reception locations and, for each of the plurality of reception locations, a plurality of sets of clustered synthetic signal information.

Another example positioning model entity includes: means for transmitting, to an apparatus configured to implement a digital twin function, a positioning model data request indicating at least one characterization parameter for at least one of determining positioning model data and reporting the positioning model data; and means for receiving, from the apparatus, positioning model data indicating a plurality of reception locations and, for each of the plurality of reception locations, a plurality of sets of clustered synthetic signal information.

An example non-transitory, processor-readable storage medium includes processor-readable instructions to cause at least one processor of a positioning model entity to: transmit, to an apparatus configured to implement a digital twin function, a positioning model data request indicating at least one characterization parameter for at least one of determining positioning model data and reporting the positioning model data; and receive, from the apparatus, positioning model data indicating a plurality of reception locations and, for each of the plurality of reception locations, a plurality of sets of clustered synthetic signal information.

An example positioning assistance method includes: receiving, at an apparatus from a requesting device, a request for positioning model data; analyzing, at the apparatus in response to receiving the request for positioning model data, a digital twin to determine a plurality of synthetic signal measurements corresponding to a combination of transmitter location and receiver location; grouping, at the apparatus, the plurality of synthetic signal measurements into at least one synthetic signal measurement cluster; determining, at the apparatus, clustered synthetic signal measurement information corresponding to each of the at least one synthetic signal measurement cluster; and transmitting, from the apparatus to the requesting device for each of the at least one synthetic signal measurement cluster, the clustered synthetic signal measurement information and an indication of the receiver location.

An example apparatus includes: at least one transceiver; at least one memory; and at least one processor, communicatively coupled to the at least one transceiver and the at least one memory, configured to: receive, via the at least one transceiver from a requesting device, a request for positioning model data; analyze, in response to receiving the request for positioning model data, a digital twin to determine a plurality of synthetic signal measurements corresponding to a combination of transmitter location and receiver location; group the plurality of synthetic signal measurements into at least one synthetic signal measurement cluster; determine clustered synthetic signal measurement information corresponding to each of the at least one synthetic signal measurement cluster; and transmit, via the at least one transceiver to the requesting device for each of the at least one synthetic signal measurement cluster, the clustered synthetic signal measurement information and an indication of the receiver location.

Another example apparatus includes: means for receiving, from a requesting device, a request for positioning model data; means for analyzing, in response to receiving the request for positioning model data, a digital twin to determine a plurality of synthetic signal measurements corresponding to a combination of transmitter location and receiver location; means for grouping the plurality of synthetic signal measurements into at least one synthetic signal measurement cluster; means for determining clustered synthetic signal measurement information corresponding to each of the at least one synthetic signal measurement cluster; and means for transmitting, to the requesting device for each of the at least one synthetic signal measurement cluster, the clustered synthetic signal measurement information and an indication of the receiver location.

Another example non-transitory, processor-readable storage medium includes processor-readable instructions to cause at least one processor of an apparatus to:
receive, from a requesting device, a request for positioning model data; analyze, in response to receiving the request for positioning model data, a digital twin to determine a plurality of synthetic signal measurements corresponding to a combination of transmitter location and receiver location; group the plurality of synthetic signal measurements into at least one synthetic signal measurement cluster; determine clustered synthetic signal measurement information corresponding to each of the at least one synthetic signal measurement cluster; and transmit, to the requesting device for each of the at least one synthetic signal measurement cluster, the clustered synthetic signal measurement information and an indication of the receiver location.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a block diagram of an example positioning model entity.

FIG. 6 is block flow diagram of an example digital twin function.

FIG. 7 is a perspective view of an environment including mobile devices, transmission/reception points, and other objects.

FIG. 8 is a ray timing diagram of multipath ray transmission and reception corresponding to a transmitter and a receiver shown in FIG. 7.

FIG. 9 is a signal and processing flow diagram for using a digital twin to provide positioning model data, using of the positioning model data to train a positioning model, and using the positioning model to determine mobile device position.

FIG. 10 is a block flow diagram of training of one or more positioning models.

FIG. 11 is a flow diagram of a positioning assistance method.

FIG. 12 is a block flow diagram of a method of obtaining and using synthetic mobile device positioning model data.

### DETAILED DESCRIPTION

Techniques are discussed herein for producing, providing, and using mobile device positioning model data. For example, a requesting device may transmit a request for mobile device positioning model data to an apparatus that is configured to implement a digital twin function (DTF, also called a digital twin management function (DTmF)). The request may indicate one or more ray tracing settings for the apparatus to use to perform ray tracing to analyze a digital twin of an area of interest for determining a location of a mobile device. The request may include one or more parameters for clustering synthetic measurements and/or one or more parameters for determining a synthetic measurement for each cluster. The apparatus may analyze the digital twin (e.g., possibly using one or more of the parameter(s) provided by the request) to determine synthetic measurements, cluster synthetic measurements, and determine a synthetic measurement for each cluster. The apparatus may use over-the-air (actual) measurements to calibrate the determined synthetic measurements. The apparatus may provide mobile device positioning model data comprising synthetic measurement information (e.g., timing, power, and/or phase of the synthetic measurement for each cluster) and corresponding location information. The requesting device may use the provided mobile device positioning model data to train, validate, and/or monitor a mobile device positioning model. The requesting device may also use over-the-air (actual) measurements to calibrate the model. In another example, a DTmF may run ray tracing and/or one or more other methodologies on a digital twin to identify propagation “rays” between transmission and reception devices and may cluster the rays based on one or more of various metrics (e.g., timing, power, relative time, delay spread, etc.) and use this to characterize a propagation path based on the clusters. The path may be represented by various propagation path parameters that may be signaled to the devices. These are example implementations, and other implementations may be implemented.

Items and/or techniques described herein may provide one or more of the following capabilities, and possibly one or more other capabilities not mentioned. Positioning accuracy may be improved. Synthetic signal measurements may be used to train, validate, and/or monitor an artificial intelligence/machine learning (AIML) model for determining position (location) of a mobile device. Synthetic signal measurements may be abstracted to facilitate use of synthetic signal measurements to train, validate, and/or monitor a positioning model. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals (RS) to enable mobile device to perform positioning measurements. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination. The term “RS” (including different types of RS, e.g., PRS, CRS, SRS) includes the singular (reference signal) and the plural (reference signals).

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

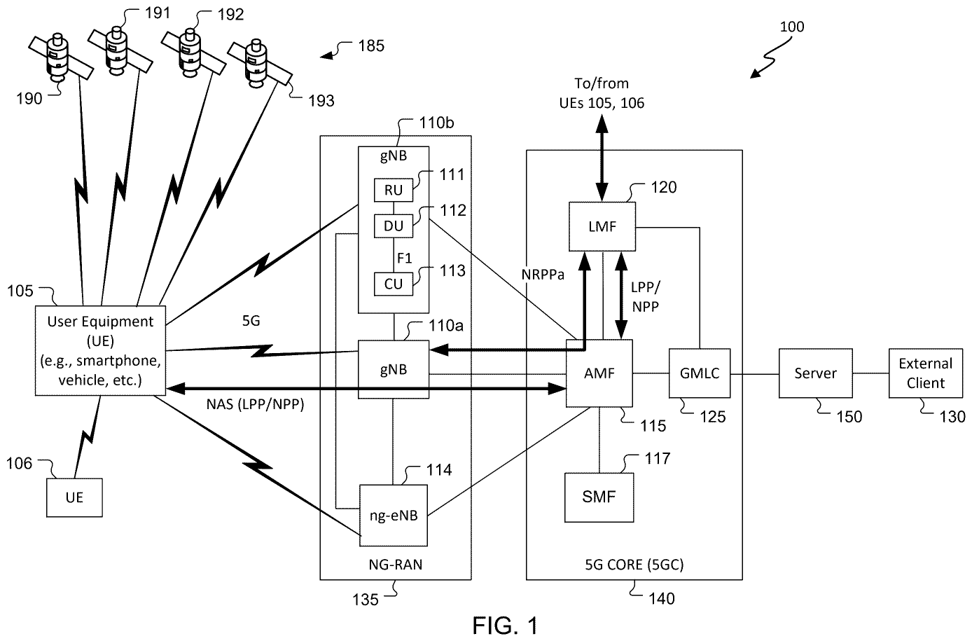

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5 GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5 GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5 GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110 a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

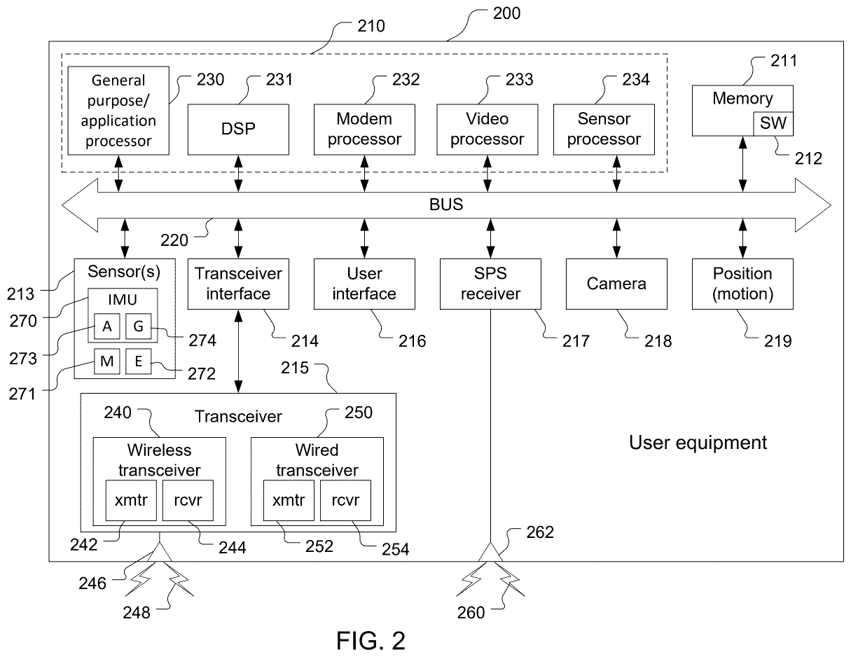

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

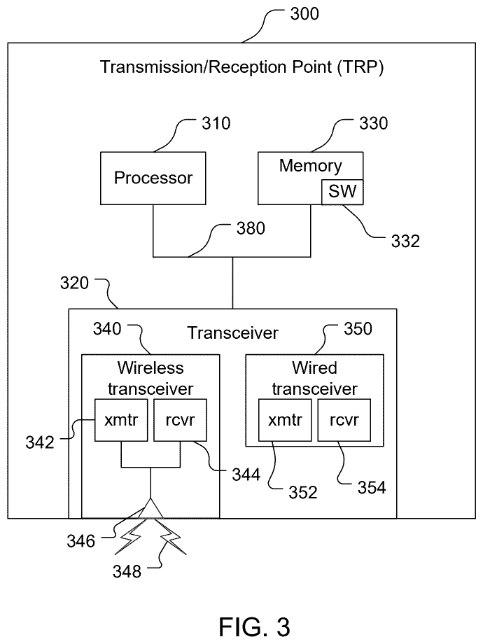

Referring also to FIG. 3, an example of a TRP 300 of the gNBs 110a, 110b and/or the ng-eNB 114 may comprise a computing platform including a processor 310, memory 330 including software (SW) 332, and a transceiver 320. Even if referred to in the singular, the processor 310 may include one or more processors, the transceiver 320 may include one or more transceivers (e.g., one or more transmitters and/or one or more receivers), and/or the memory 330 may include one or more memories. The processor 310, the memory 330, and the transceiver 320 may be communicatively coupled to each other by a bus 380 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 330 may be a non-transitory storage medium that may include random access memory (RAM)), flash memory, disc memory, and/or read-only memory (ROM), etc. The memory 330 may store the software 332 which may be processor-readable, processor-executable software code containing instructions that are configured to, when executed, cause the processor 310 to perform various functions described herein. Alternatively, the software 332 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 330) of the TRP 300 (and thus of one of the gNBs 110a, 110b and/or the ng-eNB 114) performing the function. The processor 310 may include a memory with stored instructions in addition to and/or instead of the memory 330. Functionality of the processor 310 is discussed more fully below.

The transceiver 320 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

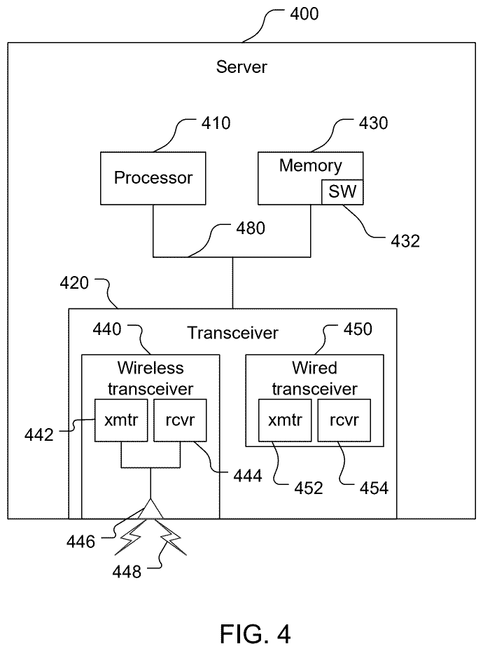

Referring also to FIG. 4, a server 400, of which the LMF 120 may be an example, may comprise a computing platform including a processor 410, memory 430 including software (SW) 432, and a transceiver 420. Even if referred to in the singular, the processor 410 may include one or more processors, the transceiver 420 may include one or more transceivers (e.g., one or more transmitters and/or one or more receivers), and/or the memory 430 may include one or more memories. The processor 410, the memory 430, and the transceiver 420 may be communicatively coupled to each other by a bus 480 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 430 may be a non-transitory storage medium that may include random access memory (RAM)), flash memory, disc memory, and/or read-only memory (ROM), etc. The memory 430 may store the software 432 which may be processor-readable, processor-executable software code containing instructions that are configured to, when executed, cause the processor 410 to perform various functions described herein. Alternatively, the software 432 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 430. Functionality of the processor 410 is discussed more fully below.

The transceiver 420 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information—Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

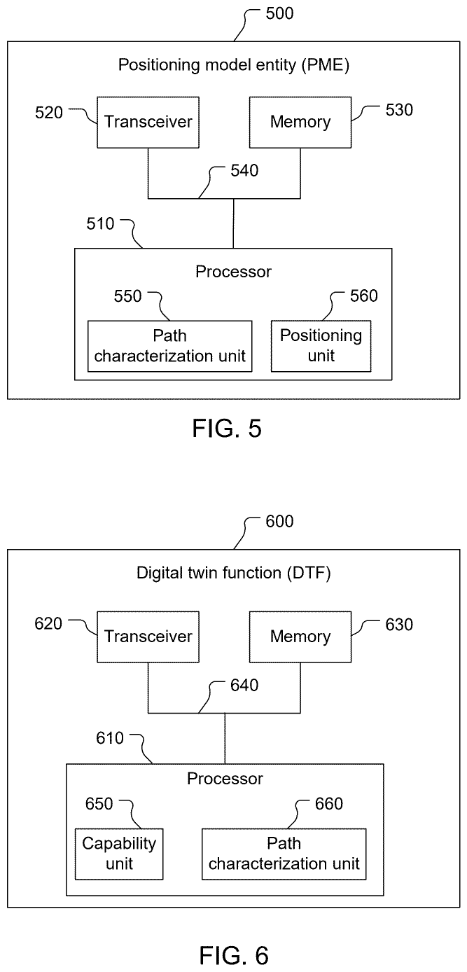

Referring also to FIG. 5, an PME 500 (Positioning Model Entity) includes a processor 510, a transceiver 520, and a memory 530 communicatively coupled to each other by a bus 540. Even if referred to in the singular, the processor 510 may include one or more processors, the transceiver 520 may include one or more transceivers (e.g., one or more transmitters and/or one or more receivers), and/or the memory 530 may include one or more memories. The PME 500 may be any of a variety of entities, e.g., a UE, a positioning reference unit (PRU), an LMF (e.g., the server 400), a gNB/TRP, an NWDAF (Network Data Analytic Function), etc. The PME 500 may include the components shown in FIG. 5. The PME 500 may include one or more other components such as any of those shown in FIG. 2 such that the UE 200 may be an example of the PME 500 or the PME 500 may be a part of the UE 200. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. As another example, the PME may include components shown in FIG. 3, with the TRP 300 being an example of the PME 500 or the PME 500 being a part of the TRP 300. As another example, the PME 500 may include components shown in FIG. 4, with the server 400 being an example of the PME 500 or the PME 500 being a part of the server 400.

The description herein may refer to the processor 510 performing a function, but this includes other implementations such as where the processor 510 executes software (stored in the memory 530) and/or firmware. The description herein may refer to the PME 500 performing a function as shorthand for one or more appropriate components (e.g., the processor 510 and the memory 530) of the PME 500 performing the function. The processor 510 (possibly in conjunction with the memory 530 and, as appropriate, the transceiver 520) may include a path characterization unit 550 and a positioning unit 560. The path characterization unit 550 may be configured to transmit requests for path characterizations, including one or more parameters for analyzing a digital twin to determine synthetic signal measurements. The positioning unit 560 may be configured to perform positioning operations (e.g., training, validating, and/or monitoring an AIML (Artificial Intelligence/Machine Learning) model for determining mobile device position estimates. The path characterization unit 550 and the positioning unit 560 are discussed further below, and the description may refer to the processor 510 generally, or the PME 500 generally, as performing any of the functions of the path characterization unit 550 and/or the positioning unit 560, with the PME 500 being configured to perform the function(s).

Referring also to FIG. 6, a DTF 600 (Digital Twin Function, also called a Digital Twin management Function (DTmF)) includes a processor 610, a transceiver 620, and a memory 630 communicatively coupled to each other by a bus 640. Even if referred to in the singular, the DTF 600 may include one or more network entities, the processor 610 may include one or more processors, the transceiver 620 may include one or more transceivers (e.g., one or more transmitters and/or one or more receivers), and/or the memory 630 may include one or more memories. The DTF 600 may be configured to manage digital-twin-related operations. The DTF 600 may be any of a variety of entities, e.g., a core-network entity, an LMF, an NWDAF (Network Data Analytic Function), an O-RAN entity (Open Radio Access Network entity) (e.g., an SMO (Service Management and Orchestration)), a UE, a PRU, a gNB (or other base station/TRP), an OAM (Operation And Management) entity, etc. An OAM entity may be used to service and maintain base stations, e.g., to turn base stations ON and OFF, to monitor base station temperature, etc. The DTF 600 may include the components shown in FIG. 6 and may be configured to be a component of a communication network (e.g., a terrestrial communication network such as a cellular network). The DTF 600 may include one or more other components such as any of those shown in FIG. 4 such that the server 400 may be an example of the DTF 600 or the DTF 600 may be part of the server 400. For example, the processor 610 may include one or more of the components of the processor 410. The transceiver 620 may include one or more of the components of the transceiver 420. The memory 630 may be configured similarly to the memory 430, e.g., including software with processor-readable instructions configured to cause the processor 610 to perform functions. Also or alternatively, the DTF 600 may include one or more other components such as any of those shown in FIG. 3 such that the TRP 300 may be an example of the DTF 600 or the DTF 600 may be part of the TRP 300. For example, the processor 610 may include one or more of the components of the processor 310. The transceiver 620 may include one or more of the components of the transceiver 320. The memory 630 may be configured similarly to the memory 330, e.g., including software with processor-readable instructions configured to cause the processor 610 to perform functions. As another example, the DTF 600 may include components shown in FIG. 2, with the UE 200 being an example of the DTF 600 or the DTF 600 being a part of the UE 200.

The description herein may refer to the processor 610 performing a function, but this includes other implementations such as where the processor 610 executes software (stored in the memory 630) and/or firmware. The description herein may refer to the DTF 600 performing a function as shorthand for one or more appropriate components (e.g., the processor 610 and the memory 630) of the DTF 600 performing the function. The processor 610 (possibly in conjunction with the memory 630 and, as appropriate, the transceiver 620) may include a capability unit 650, an AIML unit 660 (Artificial Intelligence / Machine Learning unit), and an MHP unit 670 (Multi-Hypothesis Positioning unit). The units 650, 660, 670 are discussed further below, and the description may refer to the processor 610 generally, or the DTF 600 generally, as performing any of the functions of the units 650, 660, 670, with the DTF 600 being configured to perform the function(s).

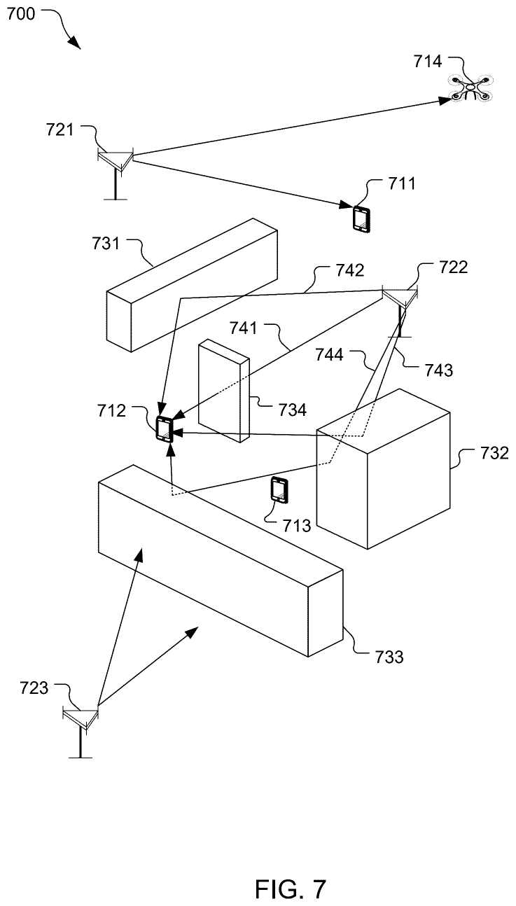

Referring also to FIG. 7, an environment 700 containing multiple mobile devices 711, 712, 713, 714 for which locations (also known as location estimates, positions, and/or position estimates) may be desired to be known/determined. In the environment, there are multiple TRPs 721, 722, 723 and multiple objects 731, 732, 733, 734 that present potential obstructions between TRPs and mobile devices. In the example environment 700, the mobile devices 711-713 are mobile phones, the mobile device 714 is an unoccupied aerial vehicle (UAV), the objects 731-733 are buildings, and the object 734 is a wall. The presence of the objects 731-734 in the environment 700 may result in the environment 700 being a challenging environment for positioning, with multipath signaling between one or more of the TRPs 721-723 and one or more of the mobile devices 711-714. For example, a signal transmitted from the TRP 722 may take a direct path 741 and a reflected path 742 to reach the mobile device 712.

A digital twin approach is discussed herein for determining synthetic signal measurements, e.g., for use in a positioning model to determine mobile device position estimates (location estimates). For example, a digital twin may be used to determine expected signal measurements at various locations from various signal transmission sources. The expected signal measurements determined using the digital twin are synthetic signal measurements and may be reported along with indications of the signal sources and the signal reception location.

A digital twin (DT) may be a digital replica of an existing entity in the real world that characterizes and models the behavior, interactions, state, and/or evolution over time of the existing entity. A DT may be constructed, e.g., by the DTF 600, for a wireless channel (e.g., DT channel and DT RAN (including radios and transmitted waveforms)). For example, ray tracing (RT) may be used to model the DT by modeling radio propagations to predict outcomes of signal transmission and reception. Various methods of ray tracing may be used, such as shoot-and-bounce ray tracing, an image method, or a hybrid method.

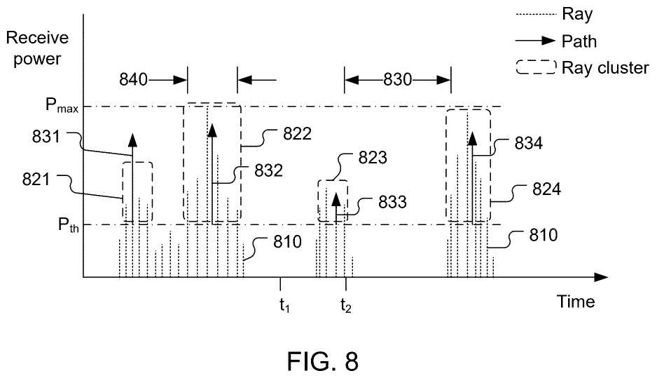

Referring also to FIG. 8, an example of synthetic multipath signaling between the TRP 722 and the mobile device 712 determined by DT analysis is shown. In this example, a signal is transmitted by the TRP 722 directly toward the mobile device 712 along the direct path 741 which is an LOS path (line-of-sight path) and along the reflected path 742, and at least two other reflected paths 743, 744. The DTF 600, e.g., the path characterization unit 660, may determine multiple rays that may be traced directly or indirectly (by reflection) from the TRP 722 to the mobile device 712, with the rays having corresponding synthetic signal measurements 810 (here time of arrival and received power (signal strength)) at the Rx location of the mobile device 712. The term “ray” may be used herein as shorthand to refer to the synthetic signal measurements corresponding to a ray. The DTF 600 may provide multiple synthetic measurements for each ray, e.g., received power, phase, and/or timing information (e.g., time of arrival, time of flight (ToF), and/or RSTD, etc.). Multiple rays transmitted from the Tx location may reach the Rx with different characteristics (e.g., different receive times, different receive powers, different phases, etc.). The rays may be grouped by the path characterization unit 660 into clusters with the rays of a cluster travelling what can be considered a single path. For example, as shown, the rays 810 may be grouped into clusters 821, 822, 823, 824 corresponding to paths 831, 832, 833, 834, respectively. To be included in a cluster, rays may be required to meet one or more criteria, e.g., that a received power be at least a threshold power Pₜₕ, that the rays are within a delay spread (time window) threshold of each other (e.g., based on time of arrival, time of flight, and/or RSTD), that the clusters not overlap (e.g., in time of arrival), that the clusters are separated by a minimum inter-cluster spacing (e.g., a inter-cluster spacing 830 between a latest ToA of a ray in one cluster and an earliest ToA of a ray in the next cluster in time must be at least a minimum time), etc. The delay spread may be a maximum width of the clusters 821-824, e.g., a delay spread 840 of the group 812 must be no greater than the delay spread threshold. The DTF 600, e.g., the path characterization unit 660, may use the measurements of rays to determine a cluster, and may use the rays of a cluster to determine a path corresponding to the cluster in accordance with one or more path characterization parameters (specified by the PME 500 and/or stored by the DTF 600). The term “path” may refer to the physical route (including, as appropriate, the reflection(s)) between the Tx and Rx locations and to the synthetic measurement corresponding to a ray cluster. Each of the one or more measurements of a path may be the corresponding measurement of a selected one of the rays in the respective cluster (e.g., the ray with the earliest time of arrival, the ray with the median time of arrival, the ray with the strongest received power, etc.) or a combination of measurements of rays in the cluster, e.g., an average of each of the respective measurements of the rays in the cluster (with a corresponding average time of arrival time). For example, as shown in FIG. 8, the path 831 for the cluster 821 is the second ray, each of the paths 832, 834 for the clusters 822, 824 is an average ray, and the path 833 for the cluster 823 is the third ray, which may be the median ray. In this example, the paths for different clusters have been determined in different ways for illustration purposes, but generally paths will be determined the same way for different clusters.

Simulation of radio propagation using ray tracing may be performed in stages. In a first stage, a model environment may be constructed based on a CAD model (Computer-Aided Design model)/map model, camera data, lidar and/or radar measurements, sensor measurements (e.g., IMU measurements, barometric measurements, etc.), RF measurements, and/or network status and/or events, etc. The model environment may comprise, e.g., a 2D model, 3D model, a radio model, a network model, and/or a traffic/application model. The model may include various characteristics, e.g., materials (permittivity, conductivity), Tx and Rx locations (transmission and reception locations), mobility, waveforms, antennas (type(s) and location(s)), number of reflections, number of penetrations, number of diffractions, scattering parameters, power, etc. In a second stage, possible paths are found and validated between Tx and Rx points using a ray tracing method, e.g., a shoot-and-bounce ray (SBR) method, an image method (IM), and/or one or more hybrid methods. Ray tracing may be characterized by a variety of parameters such as ray tracing resolution parameters (e.g., an angle separation (e.g., 0.5°) between rays, a number of rays per location, and/or a number of image reflections) and radio propagation parameters (e.g., number of reflections, number of transmissions through walls, number of diffractions, etc.). In a third stage, with the model and paths established, electromagnetic (EM) calculations may be performed to determine EM fields for valid rays (e.g., using high-frequency asymptotic techniques). Any of various methodologies may be used for computing diffraction, e.g., geometric optics (GO), uniform asymptotic theory (UAT), geometric theory of diffraction (GTD), uniform theory of diffraction (UTD), physical optics, one or more spectral methods, and/or multi-edge diffraction (e.g., Deygout model, Epstein-Peterson model, etc.). Any of various methodologies may be used for computing scattering, e.g.,, Lambertian scattering, directive scattering, directive backscattering, and/or multiple scattering theory, etc. Ray tracing may be limited to a specified area/region.

Ray tracing configurations have several associated aspects. For example, ray tracing model aspects include the ray tracing method used, and include updating the model as appropriate. As objects are introduced and/or removed from an environment, e.g., due to construction and/or demolition, the model for the environment may be updated to add or remove objects as appropriate. As another example, reporting aspects include reporting content of the model and/or outcomes of using the model, a recurrence of reporting (e.g., periodic reporting, semi-persistent reporting, aperiodic reporting (e.g., triggered by occurrence of one or more events), a combination of periodic and aperiodic reporting, etc.). As another example, wireless aspects of a ray tracing configuration include locations and configurations of Tx and Rx points including antenna configurations. As another example, digital twin aspects include an area/region of the digital twin, with a corresponding reliability or confidence score that represents a network's confidence in the digital twin for the area/region.

Various ray tracing outcomes (results) may be determined and reported. For example, expected received ray information may be determined and reported, including:
electromagnetic fields (EM fields) per ray; power, arrival timing/time of flight (ToF), and/or phase per ray; polarization per ray; angle (e.g., angle of departure and/or angle of arrival); and/or ray interactions with the environment (e.g., points of reflection/diffraction/scattering, etc.). As another example, ray information per antenna pair (Tx-Rx antenna pair). As another example, one or more synthetic signal measurements (e.g., RSRP, RSRQ, SINR (Signal-to-Interference-plus-Noise Ratio), etc.) may be derived from ray tracing for each of one or more receive points.

AIML positioning can show excellent positioning accuracy in stringent NLOS conditions. Traditional positioning techniques may not yield sufficient accuracy in NLOS conditions. Inputs to an AIML model may include channel measurement, a quality indicator of the channel measurement, and a time stamp of the channel measurement. Outputs from the AIML model may include a ground truth label (or an approximation thereof), a quality indicator of the label, and a time stamp of the label. Positioning data (e.g., model input measurements and model output ground truth) may be used to train, validate, and/or monitor an AIML positioning model. Collection of the positioning data may be prohibitively expensive, e.g., to position reference devices and numerous locations, receive and measure signals at these locations from each of multiple signal sources, and to record and report the signal measurements. A less expensive method for producing labeled data is to generate the labeled data using a digital twin. Matching over-the-air (OTA) actual channel measurements using the digital twin may be difficult. Techniques are discussed herein to configure and use channel abstraction in both the DT (digital twin) domain and the OTA domain to train an AIML positioning model and to configure and use the channel abstraction during operation (also called inference) with the AIML positioning model to determine mobile device position. Channel abstraction involves analyzing multiple signal measurements derived from DT analysis (called synthetic signal measurements) to cluster signal measurements and determine representative measurement information for the cluster of signal measurements. The synthetic signal measurements may be abstracted using prominent features in order to determine synthetic signal measurements to be used in an AIML positioning model (e.g., to train the model). For example, synthetic signal measurements from the two shortest paths between a Tx location and an Rx location may be used to abstract a channel to determine measurements for training an AIML positioning model.

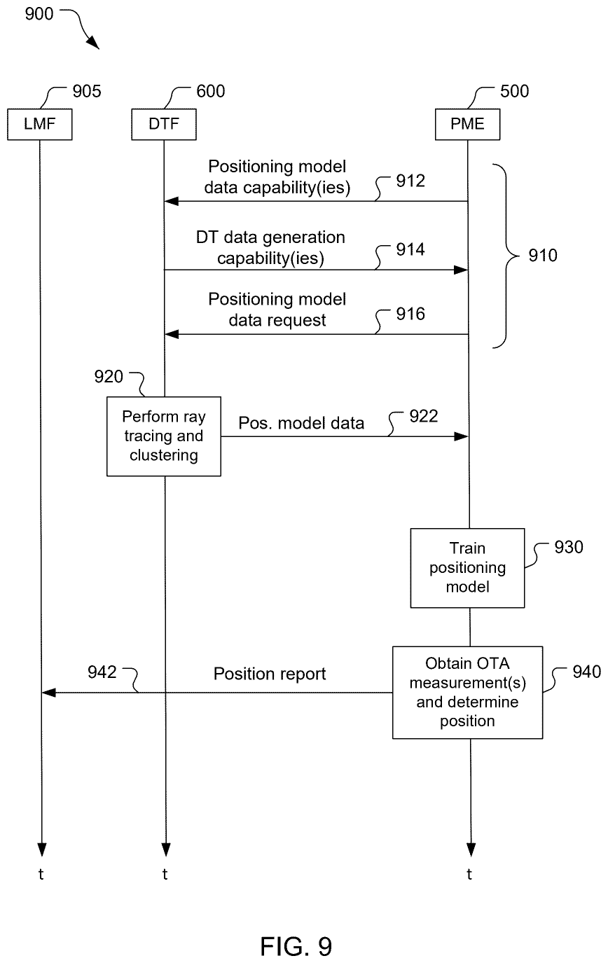

Referring also to FIG. 9, a signal and processing flow 900 for using a digital twin to provide synthetic positioning signal measurements, using these measurements to train an AIML model, and using the AIML model to determine a position estimate for a mobile device includes stages shown. The flow 900 shows an example of signaling between the DTF 600, the PME 500, and an LMF 905. The same physical entity may contain the DTF 600 and the PME 500, such that the same physical entity may request positioning model data, determine and provide the positioning model data, and use the provided signaling model data. The flow 900 is an example flow and not limiting. The flow 900 may be altered, e.g., by having one or more messages and/or one or more stages added, removed, rearranged, combined, performed concurrently, and/or having one or more messages and/or one or more stages split into multiple messages and/or stages.

At stage 910, the PME 500, e.g., the path characterization unit 550, may transmit a capability message 912 to the DTF 600. The capability message 912 may indicate the ability of the PME 500 to use positioning model data. The capability message 912 may indicate the ability of the PME 500 to train a positioning model using the positioning model data.

Also at stage 910, the DTF 600, e.g., the capability unit 650, may transmit a capability message 914 to the PME 500 indicating supported functionality of the DTF 600 (i.e., functions that the DTF 600 is configured to perform). For example, the DTF 600 may broadcast the capability message 914 such that any PME 500 within communication range of the entity (e.g., a TRP) broadcasting the message 914 may receive the message 914. The capability unit 650 may transmit the capability message 914 based on (e.g., in response to, such as only in response to) receiving the capability message 912 from the PME 500. The capability message 914 may indicate one or more DT data generation capabilities of the DTF 600 for generating DT data including AIML positioning model input data and AIML positioning model output data. For example, the capability(ies) may include supported ray tracing methodologies and/or ray tracing settings (e.g., ray tracing resolution parameters), supported clustering capability (e.g., a maximum number of signal measurement clusters (e.g., for each combination of Tx location and Rx location), a maximum delay spread for clusters, and/or a minimum received power threshold for cluster consideration, etc.), supported path characterization technique(s) (e.g., use earliest ray in a cluster, use average of rays in a cluster, etc.), supported Tx/Rx antenna propagation, supported Tx/Rx beam codebooks, supported Tx/Rx group delays and timing errors, supported material types, supported models (e.g., 3D, 2D), supported number of rays per Tx location, and/or supported ray resolution per Rx location, etc.

Also at stage 910, the PME 500, e.g., the path characterization unit 550, may transmit a positioning model data request 916 to the DTF 600. The request 916 may indicate one or more characterization parameters (which may be called abstraction/characterization parameters) for use by the DTF 600 to determine and/or report positioning model data, e.g., synthetic signal measurements and corresponding Rx locations. The characterization parameters in the request 916 may indicate an area/region for which positioning model data is desired. The parameters in the request 916 may indicate one or more cluster parameters for the DTF 600 to use to determine at least one synthetic signal measurement cluster of a plurality of synthetic signal measurements corresponding to each of multiple locations. The cluster parameter(s) provide instruction for how the DTF 600 is to map rays into paths. The cluster parameter(s) may include, e.g., a maximum number of clusters (and thus paths) that can be determined for each Tx location/Rx location combination, a minimum power threshold for a ray to be in a cluster, a delay spread (e.g., maximum window of times of arrival of rays within a cluster), whether clusters may overlap, a minimum time of arrival separation between rays of different clusters, etc.). Also or alternatively, the characterization parameters in the request 916 may indicate one or more path characterization parameters for the DTF 600 to use to determine synthetic signal measurement information corresponding to each of the at least one synthetic signal measurement cluster. For example, the path characterization parameter(s) may indicate, in order to determine the signal measurement(s) for a cluster, to use an earliest time of arrival ray in a cluster, to use average of rays in a cluster, to use the highest received signal strength array in a cluster, or to use the median time of arrival array in a cluster, etc.). Also or alternatively, the characterization parameters in the request 916 may indicate one or more ray tracing settings for the DTF 600 to use to analyze a digital twin to determine synthetic signal measurements. The ray tracing settings may indicate one or more aspects of one or more ray tracing configurations discussed herein. The PME 500 may use the capability(ies) 914 indicated in the message 914 to affect the content of the request 916, e.g., not to request a capability not indicated in the message 914 as being supported by the DTF 600. The request 916 may indicate one or more parameters regarding reporting of positioning model data by the DTF 600 to the PME 500 (e.g., condition(s) triggering reporting, and/or periodicity of reporting, etc.).

At stage 920, the DTF 600, e.g., the path characterization unit 660, performs ray tracing and clustering. The path characterization unit 660 to determine rays, group rays into clusters, analyze the clusters to determine paths, and provide positioning model data (e.g., indications of synthetic signal measurement(s) and location) for one or more Rx locations, e.g., within the area/region indicated in the request 916. The DTF 600 may determine the rays and paths as discussed herein. The DTF 600 may determine the rays and paths based the parameters indicated in the request 916, or may ignore one or more (and possibly all) of the parameters indicated in the request 916 to determine the positioning model data. Thus, the parameters for clustering may be configured by the PME 500 (the requesting entity) and/or by the DTF 600. The DTF 600 may provide positioning model data for each determined cluster/path (e.g., one or more synthetic signal measurements (e.g., ToA, ToF, RSSI, RSRP, phase, etc.) to the PME 500.

The DTF 600 may transmit the positioning model data to the PME 500 in a positioning model data message 922. The DTF 600 may transmit the positioning model data message 922 in accordance with one or more reporting parameters indicated in the request 916. The positioning model data message 922 may include less data than determined by the DTF 600 or requested by the PME 500, e.g., synthetic signal measurements for fewer clusters than determined or requested. The positioning model data message 922 may indicate that the positioning model data includes synthetic measurement data (i.e., measurement data based on a simulated environment and not based on actual signal measurements). The positioning model data (e.g., measurements and/or labels) of the message 922 may be annotated with metadata describing the data as being synthetic, being generated from a digital twin. The metadata may describe the DT settings (e.g., ray tracing configurations) used to determine the positioning model data. This may be helpful for the PME 500 when training an AIML positioning model. The DTF 600 may validate/calibrate the positioning model data produced using the DT, e.g., by comparing the positioning model data with corresponding data determined from OTA measurements.

A new communication protocol may be used for communication between the PME 500 and the DTF 600, e.g., if the DTF 600 and the PME 500 are implemented by different physical entities. For example, the message 914, the request 916, and/or the message 922 may be transmitted using a new LPP/NRPPa.

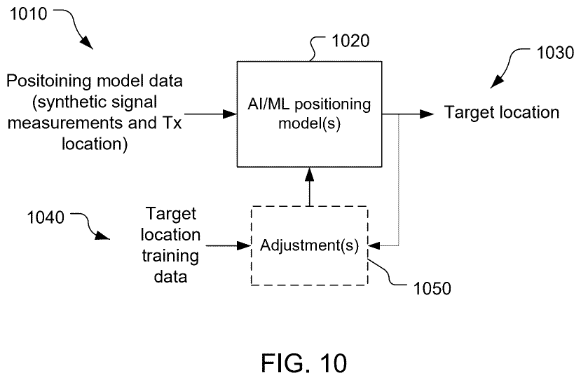

Referring also to FIG. 10, at stage 930, the PME 500, e.g., the positioning unit 560, may train a positioning model, e.g., an AIML positioning model using the positioning model data provided in the message 922. The positioning unit 560 may use positioning model data 1010 provided in the message 922 as input to one or more AIML positioning model(s) 1020 to produce a candidate location estimate 1030 of a target mobile device (whose location is to be determined). The positioning model data 1010 includes one or more synthetic signal measurements for each path, along with a corresponding Tx location and/or a transmitter ID. Synthetic signal measurements corresponding to multiple Tx locations may be provided for the same Rx location. The positioning unit 560 may also use OTA signal measurements as input to the AIML positioning model(s) 1020 to calibrate DT-generated positioning model data and, if so, may weight the positioning model data 1010 provided in the message 922 less than the OTA signal measurements. The positioning unit 560 may use target location training data 1040 (e.g., Rx locations corresponding to respective sets of the positioning model data 1010) to determine one or more model adjustments 1050 and use the adjustment(s) 1050 to alter the AIML positioning model(s) 1020. After initial training of the positioning model, positioning model data from the DTF 600 may be used to validate/monitor/update the model. The path information from the DTF 600 (i.e., the synthetic signal measurement(s), Rx location, and possibly Tx location(s)) may be used to validate the AIML positioning model (before and/or after deployment of the AIML positioning model for determining mobile device position). The path information from the DTF 600 may also or alternatively be used to monitor the AIML positioning model, e.g., accuracy of the target mobile device locations output by the AIML positioning model during operation.

One or more conditions may be monitored to ensure use of accurate positioning model data provided by the DTF 600. For example, depending on a positioning method being used, the positioning model data provided in the message 922 may be accepted and used without condition, accepted based on existing (e.g., RAN4) requirements of existing positioning methods, or accepted based on agreement with OTA data. For example, the data provided in the message 922 may be accepted under condition that timing of each of one or more DT-generated paths is within a threshold time difference (before or after) timing of the respective OTA signal measurement.

At stage 940, the PME 500, e.g., the positioning unit 560, may obtain OTA measurement(s) and determine a mobile device position. For example, the PME 500 may measure OTA signals or receive OTA measurements from another device and input the OTA measurements (including indication(s) of the transmitter(s) of the OTA signals) into a positioning model, e.g., the AIML model 1020, to determine a location estimate for a mobile device (e.g., the PME 500 if the PME 500 is a UE that measures the OTA signals). The PME 500 may transmit the location estimate to the LMF 905 in a position report 942.

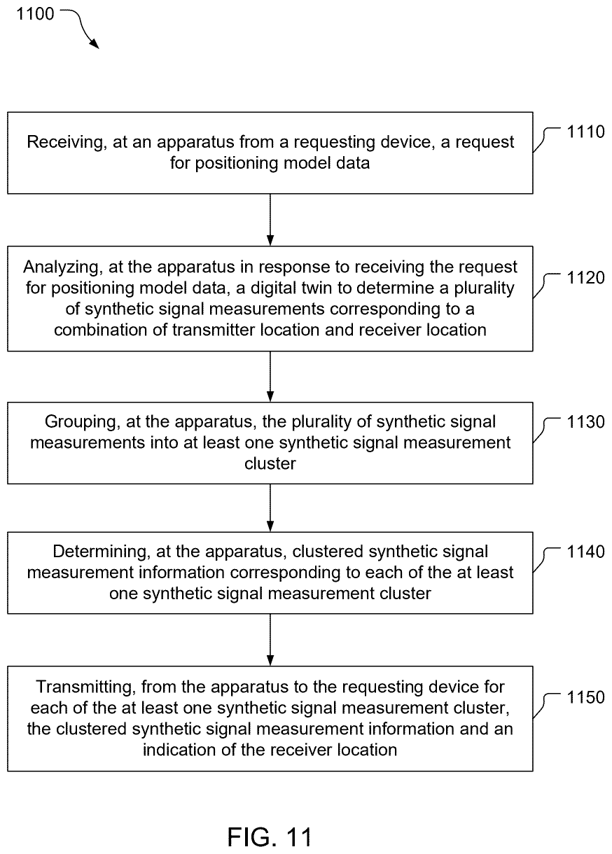

Referring to FIG. 11, with further reference to FIGS. 1-10, a positioning assistance method 1100 includes the stages shown. The method 1100 is, however, an example only and not limiting. The method 1100 may be altered, e.g., by having one or more stages added, removed, rearranged, combined, performed concurrently, and/or by having one or more single stages split into multiple stages.

At stage 1110, the method 1100 includes receiving, at an apparatus from a requesting device, a request for positioning model data. For example, at stage 910 the DTF 600 may receive the positioning model data request 916 from the PME 500. The processor 610, possibly in combination with the memory 630, possibly in combination with the transceiver 620 (if the PME 500 and the DTF 600 are implemented by separate physical entities) may comprise means for receiving a request for positioning model data.

At stage 1120, the method 1100 includes analyzing, at the apparatus in response to receiving the request for positioning model data, a digital twin to determine a plurality of synthetic signal measurements corresponding to a combination of transmitter location and receiver location. For example, at stage 920 the DTF 600 may perform ray tracing (possibly based on one or more parameters specified in the positioning model data request 916) to determine synthetic signal measurements (e.g., corresponding to the rays 810). Each determined ray has an associated Tx location and Rx location, and one or more synthetic signal measurements (e.g., ToA, ToF, RSTD, RSSI, etc.). The processor 610, possibly in combination with the memory 630, may comprise means for analyzing a digital twin to determine a plurality of synthetic signal measurements.

At stage 1130, the method 1100 includes grouping, at the apparatus, the plurality of synthetic signal measurements into at least one synthetic signal measurement cluster. For example, at stage 920, the DTF 600 groups rays, e.g., the rays 810, into one or more clusters, e.g., the clusters 821-824, based on one or more cluster parameters (e.g., provided in the request 916 and/or stored in the memory 630). The processor 610, possibly in combination with the memory 630, may comprise means for grouping the plurality of synthetic signal measurements into at least one cluster.

At stage 1140, the method 1100 includes determining, at the apparatus, clustered synthetic signal measurement information corresponding to each of the at least one synthetic signal measurement cluster. For example, at stage 920, the DTF 600 may determine paths, e.g., the paths 831-834, based on one or more cluster parameters (e.g., received in the request 916 and/or stored in the memory 630). The processor 610, possibly in combination with the memory 630, may comprise means for determining clustered synthetic signal measurement information.

At stage 1150, the method 1100 includes transmitting, from the apparatus to the requesting device for each of the at least one synthetic signal measurement cluster, the clustered synthetic signal measurement information and an indication of the receiver location. For example, at stage 920, the DTF 600 may transmit the positioning model data message 922 to the PME 500, with the message 922 including the paths (including one or more synthetic signal measurements for the respective cluster for each of the paths, and the Tx location for each path) and the Rx location (corresponding to each set of clusters, with different sets of clusters associated with different Rx locations). The processor 610, possibly in combination with the memory 630, possibly in combination with the transceiver 620 (if the PME 500 and the DTF 600 are implemented by separate physical entities) may comprise means for transmitting the clustered synthetic signal measurement information and the indication of the receiver location.

Implementations of the method 1100 may include one or more of the following features. In an example implementation, grouping the plurality of synthetic signal measurements comprises grouping the plurality of synthetic signal measurements based on at least one cluster parameter received in the request for positioning model data. As mentioned, the DTF 600 may determine clusters based on one or more cluster parameters indicated in the request 916 (and possibly one or more cluster parameters stored in the memory 630, while possibly ignoring on one or more cluster parameters indicated in the request 916). Alternatively, the DTF 600 may determine clusters by ignoring all the cluster parameters indicated in the request 916. In a further example implementation, the at least one cluster parameter comprises at least one of a number of clusters to be determined (e.g., an exact number of clusters to be determined, or a maximum number of clusters that may be determined (or at least reported)), a delay spread per cluster, and a measurement threshold for each of the plurality of synthetic signal measurements.

Also or alternatively, implementations of the method 1100 may include one or more of the following features. In an example implementation, determining the clustered synthetic signal measurement information comprises determining the clustered synthetic signal measurement information based on at least one path characterization parameter received in the request for positioning model data. As mentioned, the DTF 600 may determine the path (i.e., the synthetic signal measurement for each cluster) based on one or more path characterization parameters indicated in the request 916 (and possibly one or more cluster parameters stored in the memory 630, while possibly ignoring on one or more cluster parameters indicated in the request 916). Alternatively, the DTF 600 may determine the path by ignoring all the path parameters indicated in the request 916. In a further example implementation, the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Also or alternatively, implementations of the method 1100 may include one or more of the following features. In an example implementation, analyzing the digital twin comprises analyzing the digital twin based on at least one ray tracing setting received in the request for positioning model data. The DTF 600 may perform ray tracing based on one or more ray tracing settings (e.g., ray tracing configuration(s) and/or ray tracing aspect(s) of one or more ray tracing configurations) indicated in the request 916 (and possibly one or more ray tracing settings stored in the memory 630, while possibly ignoring on one or more ray tracing settings indicated in the request 916). Alternatively, the DTF 600 may perform ray tracing while ignoring all the ray tracing settings indicated in the request 916. In another example implementation, the method 1100 includes transmitting, from the apparatus, a capability message indicating at least one supported capability for determining the clustered synthetic signal measurement information. For example, at stage 910, the DTF 600 may transmit the capability message 914. The DTF 600 may transmit the capability message 914 based on or in response to receiving the capability message 912 (e.g., only if the DTF 600 previously received the capability message 912) and the message 912 indicated that the PME 500 could use positioning model data. The processor 610, possibly in combination with the memory 630, possibly in combination with the transceiver 620 (if the PME 500 and the DTF 600 are implemented by separate physical entities) may comprise means for transmitting the capability message. In another example implementation, the method 1100 includes transmitting, from the apparatus to the requesting device, an indication that the clustered synthetic signal measurement information includes synthetic, digital-twin-based measurement information. For example, at stage 920, the positioning model data message 922 may include one or more indications, e.g., in metadata, that positioning model data provided in the message 922 includes synthetic signal measurement data. The indication(s) may specify which signal measurements are synthetic signal measurements and/or may indicate that the synthetic signal measurement data are data produced from digital twin analysis.

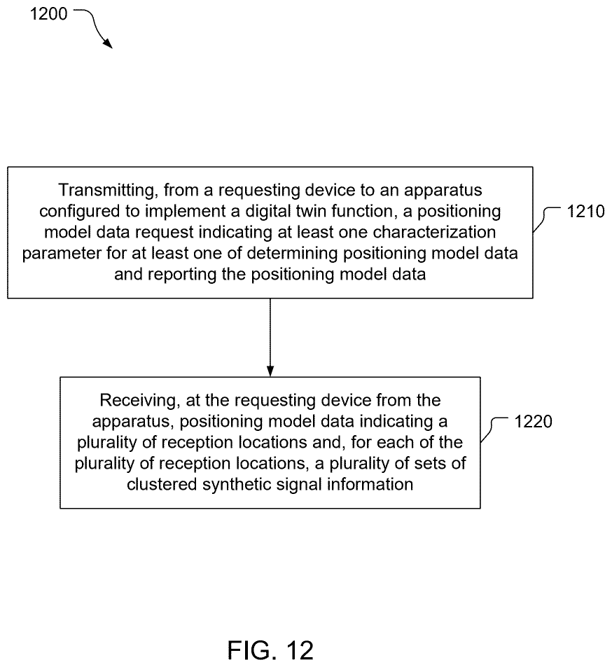

Referring to FIG. 12, with further reference to FIGS. 1-10, a method 1200, of obtaining and using synthetic mobile device positioning model data, includes the stages shown. The method 1200 is, however, an example only and not limiting. The method 1200 may be altered, e.g., by having one or more stages added, removed, rearranged, combined, performed concurrently, and/or by having one or more single stages split into multiple stages.

At stage 1210, the method 1200 includes transmitting, from a requesting device to an apparatus configured to implement a digital twin function, a positioning model data request indicating at least one characterization parameter for at least one of determining positioning model data and reporting the positioning model data. For example, at stage 910, the PME 500 may transmit the positioning model data request 916 to the DTF 600, with the request 916 indicating one or more cluster parameters, one or more path characterization parameters, and/or one or more ray tracing settings. The processor 510, possibly in combination with the memory 530, possibly in combination with the transceiver 520 (if the PME 500 and the DTF 600 are implemented by separate physical entities) may comprise means for transmitting the positioning model data request.

At stage 1220, the method 1200 includes receiving, at the requesting device from the apparatus, positioning model data indicating a plurality of reception locations and, for each of the plurality of reception locations, a plurality of sets of clustered synthetic signal information. For example, at stage 920, the PME 500 may receive the positioning model data message 922 with path information for multiple reception locations. The path information may include multiple sets of synthetic signal information (e.g., with each set including one or more synthetic signal measurements) for each of multiple Rx locations. The processor 510, possibly in combination with the memory 530, possibly in combination with the transceiver 520 (if the PME 500 and the DTF 600 are implemented by separate physical entities) may comprise means for receiving the positioning model data.

Implementations of the method 1200 may include one or more of the following features. In an example implementation, the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements. In a further example implementation, the positioning model data request indicates the at least one cluster parameter, and wherein the at least one cluster parameter comprises at least one of a number of clusters to be determined (e.g., an exact number of clusters to be determined or a maximum number of clusters to be determined), a delay spread per cluster, and a measurement threshold for each of the plurality of synthetic signal measurements. In another further example implementation, the positioning model data request indicates the at least one path characterization parameter, and the at least one path characterization parameter indicates for the clustered synthetic signal measurement information to be determined, for each of the at least one synthetic signal measurement cluster, from one of a median time of arrival synthetic signal measurement (a measurement from a ray with a median time of arrival of rays within a cluster), a highest received power synthetic signal measurement (a measurement from a ray with a highest received power of rays within a cluster), an average time of arrival synthetic signal measurement (an average of measurements from all rays within a cluster), and an earliest time of arrival synthetic signal measurement (a measurement from a ray with the earliest time of arrival of rays within a cluster).

Also or alternatively, implementations of the method 1200 may include one or more of the following features. In an example implementation, the method 1200 includes receiving, at the requesting device from the apparatus, a capability message indicating at least one supported capability for determining the clustered synthetic signal measurement information, wherein content of the positioning model data request is based on the at least one supported capability for determining the clustered synthetic signal measurement information indicated by the capability message. For example, at stage 910, the PME 500 may receive the capability message 914 and the PME 500 may determine at least part of the request 916 based on information in the capability message 914, e.g., not to request for the DTF 600 to perform a function that the capability message 914 indicates that the DTF 600 does not support (or possibly that the capability message 914 does not indicate that the DTF 600 does support). The processor 510, possibly in combination with the memory 530, possibly in combination with the transceiver 520 (if the PME 500 and the DTF 600 are implemented by separate physical entities) may comprise means for receiving the capability message.

Also or alternatively, implementations of the method 1200 may include one or more of the following features. In an example implementation, the method 1200 includes training the mobile device positioning model based on the positioning model data, and the method 1200 further includes: receiving an indication that the plurality of sets of clustered synthetic signal information include synthetic, digital-twin-based measurements; receiving over-the-air measurements; and discounting at least some of the synthetic, digital-twin-based measurements relative to corresponding ones of the over-the-air measurements for training a mobile device positioning model. For example, the PME 500 may receive one or more indications in the message 922 that at least some of the data in the message 922 has been synthesized (as opposed to measured) from digital twin analysis. The PME 500 may also receive OTA signal measurements (e.g., from another entity and/or by measuring OTA signals) at stage 930, and weight synthetic measurements less than corresponding OTA measurements as inputs to a positioning model (e.g., the AIML positioning model 1020) to train the positioning model. The processor 510, possibly in combination with the memory 530, possibly in combination with the transceiver 520 (if the PME 500 and the DTF 600 are implemented by separate physical entities) may comprise means for receiving the indication that the plurality of sets of clustered synthetic signal information include synthetic, digital-twin-based measurements. The processor 510, possibly in combination with the memory 530, possibly in combination with the transceiver 520 may comprise means for receiving OTA measurements. The processor 510, possibly in combination with the memory 530, may comprise means for discounting at least some of the synthetic, digital-twin-based measurements.

Also or alternatively, implementations of the method 1200 may include one or more of the following features. In an example implementation, the method 1200 includes, based on the positioning model data, at least one of training a mobile device positioning model, validating an accuracy of the mobile device positioning model, and monitoring the accuracy of the mobile device positioning model. For example, at stage 930, the PME 500 may train a positioning model (e.g., an AIML positioning model), validate the accuracy of a previously-trained positioning model, and/or monitor the accuracy of a previously-trained positioning model. The processor 510, possibly in combination with the memory 530, may comprise means for at least one of training the mobile device positioning model, validating the accuracy of the mobile device positioning model, and monitoring the accuracy of the mobile device positioning model.

### Implementation Examples

Implementation examples are provided in the following numbered clauses.

Clause 1. A method, of obtaining and using synthetic mobile device positioning model data, comprising:
transmitting, from a requesting device to an apparatus configured to implement a digital twin function, a positioning model data request indicating at least one characterization parameter for at least one of determining positioning model data and reporting the positioning model data; and
receiving, at the requesting device from the apparatus, positioning model data indicating a plurality of reception locations and, for each of the plurality of reception locations, a plurality of sets of clustered synthetic signal information.

Clause 2. The method of claim 1, wherein the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements.

Clause 3. The method of claim 2, wherein the positioning model data request indicates the at least one cluster parameter, and wherein the at least one cluster parameter comprises at least one of a number of clusters to be determined, a delay spread per cluster, and a measurement threshold for each of the plurality of synthetic signal measurements.

Clause 4. The method of claim 2, wherein the positioning model data request indicates the at least one path characterization parameter, and wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 5. The method of claim 1, further comprising receiving, at the requesting device from the apparatus, a capability message indicating at least one supported capability for determining the clustered synthetic signal measurement information, wherein content of the positioning model data request is based on the at least one supported capability for determining the clustered synthetic signal measurement information indicated by the capability message.

Clause 6. The method of claim 1, wherein the method includes training a mobile device positioning model based on the positioning model data, the method further comprising:
receiving an indication that the plurality of sets of clustered synthetic signal information include synthetic, digital-twin-based measurements;
receiving over-the-air measurements; and
discounting at least some of the synthetic, digital-twin-based measurements relative to corresponding ones of the over-the-air measurements for training the mobile device positioning model.

Clause 7. The method of claim 1, further comprising, based on the positioning model data, at least one of training a mobile device positioning model, validating an accuracy of the mobile device positioning model, and monitoring the accuracy of the mobile device positioning model.

Clause 8. A positioning model entity comprising:
at least one transceiver;
at least one memory; and
at least one processor, communicatively coupled to the at least one transceiver and the at least one memory, configured to:
   transmit, via the at least one transceiver to an apparatus configured to implement a digital twin function, a positioning model data request indicating at least one characterization parameter for at least one of determining positioning model data and reporting the positioning model data; and
   receive, via the at least one transceiver from the apparatus, positioning model data indicating a plurality of reception locations and, for each of the plurality of reception locations, a plurality of sets of clustered synthetic signal information.

Clause 9. The positioning model entity of claim 8, wherein the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements.

Clause 10. The positioning model entity of claim 9, wherein the positioning model data request indicates the at least one cluster parameter, and wherein the at least one cluster parameter comprises at least one of a number of clusters to be determined, a delay spread per cluster, and a measurement threshold for each of the plurality of synthetic signal measurements.

Clause 11. The positioning model entity of claim 9, wherein the positioning model data request indicates the at least one path characterization parameter, and wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 12. The positioning model entity of claim 8, wherein the at least one processor is configured to receive, via the at least one transceiver from the apparatus, a capability message indicating at least one supported capability for determining the clustered synthetic signal measurement information, wherein the at least one processor is configured to base content of the positioning model data request on the at least one supported capability for determining the clustered synthetic signal measurement information indicated by the capability message.

Clause 13. The positioning model entity of claim 8, wherein the at least one processor is configured to train a mobile device positioning model based on the positioning model data, and the at least one processor is configured to:
receive, via the at least one transceiver, an indication that the plurality of sets of clustered synthetic signal information include synthetic, digital-twin-based measurements;
receive, via the at least one transceiver, over-the-air measurements; and
discount at least some of the synthetic, digital-twin-based measurements relative to corresponding ones of the over-the-air measurements to train the mobile device positioning model.

Clause 14. The positioning model entity of claim 8, wherein the at least one processor is configured to, based on the positioning model data, at least one of train a mobile device positioning model, validate an accuracy of the mobile device positioning model, and monitor the accuracy of the mobile device positioning model.

Clause 15. A positioning model entity comprising:
means for transmitting, to an apparatus configured to implement a digital twin function, a positioning model data request indicating at least one characterization parameter for at least one of determining positioning model data and reporting the positioning model data; and
means for receiving, from the apparatus, positioning model data indicating a plurality of reception locations and, for each of the plurality of reception locations, a plurality of sets of clustered synthetic signal information.

Clause 16. The positioning model entity of claim 15, wherein the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements.

Clause 17. The positioning model entity of claim 16, wherein the positioning model data request indicates the at least one cluster parameter, and wherein the at least one cluster parameter comprises at least one of a number of clusters to be determined, a delay spread per cluster, and a measurement threshold for each of the plurality of synthetic signal measurements.

Clause 18. The positioning model entity of claim 16, wherein the positioning model data request indicates the at least one path characterization parameter, and wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 19. The positioning model entity of claim 15, further comprising means for receiving, from the apparatus, a capability message indicating at least one supported capability for determining the clustered synthetic signal measurement information, wherein the means for transmitting the positioning model data request include means for determining content of the positioning model data request based on the at least one supported capability for determining the clustered synthetic signal measurement information indicated by the capability message.

Clause 20. The positioning model entity of claim 15, wherein the positioning model entity includes the means for training a mobile device positioning model based on the positioning model data, the positioning model entity further comprising:
means for receiving an indication that the plurality of sets of clustered synthetic signal information include synthetic, digital-twin-based measurements;
means for receiving over-the-air measurements; and
means for discounting at least some of the synthetic, digital-twin-based measurements relative to corresponding ones of the over-the-air measurements for training the mobile device positioning model.

Clause 21. The positioning model entity of claim 15, further comprising means for, based on the positioning model data, at least one of training a mobile device positioning model, validating an accuracy of the mobile device positioning model, and monitoring the accuracy of the mobile device positioning model.

Clause 22. A non-transitory, processor-readable storage medium comprising processor-readable instructions to cause at least one processor of a positioning model entity to:
transmit, to an apparatus configured to implement a digital twin function, a positioning model data request indicating at least one characterization parameter for at least one of determining positioning model data and reporting the positioning model data; and
receive, from the apparatus, positioning model data indicating a plurality of reception locations and, for each of the plurality of reception locations, a plurality of sets of clustered synthetic signal information.

Clause 23. The non-transitory, processor-readable storage medium of claim 22, wherein the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements.

Clause 24. The non-transitory, processor-readable storage medium of claim 23, wherein the positioning model data request indicates the at least one cluster parameter, and wherein the at least one cluster parameter comprises at least one of a number of clusters to be determined, a delay spread per cluster, and a measurement threshold for each of the plurality of synthetic signal measurements.

Clause 25. The non-transitory, processor-readable storage medium of claim 23, wherein the positioning model data request indicates the at least one path characterization parameter, and wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 26. The non-transitory, processor-readable storage medium of claim 22, further comprising processor-readable instructions to cause the at least one processor to receive, from the apparatus, a capability message indicating at least one supported capability for determining the clustered synthetic signal measurement information, wherein the processor-readable instructions to cause the at least one processor transmit the positioning model data request include processor-readable instructions to cause the at least one processor determine content of the positioning model data request based on the at least one supported capability for determining the clustered synthetic signal measurement information indicated by the capability message.

Clause 27. The non-transitory, processor-readable storage medium of claim 22, wherein the processor-readable instructions include the processor-readable instructions to cause the at least one processor to train a mobile device positioning model based on the positioning model data, the non-transitory, processor-readable storage medium further comprising processor-readable instructions to cause the at least one processor to:
receive an indication that the plurality of sets of clustered synthetic signal information include synthetic, digital-twin-based measurements;
receive over-the-air measurements; and
discount at least some of the synthetic, digital-twin-based measurements relative to corresponding ones of the over-the-air measurements for training the mobile device positioning model.

Clause 28. The non-transitory, processor-readable storage medium of claim 22, further comprising processor-readable instructions to cause the at least one processor to, based on the positioning model data, at least one of train a mobile device positioning model, validate an accuracy of the mobile device positioning model, and monitor the accuracy of the mobile device positioning model.

Clause 29. A positioning assistance method comprising:
receiving, at an apparatus from a requesting device, a request for positioning model data;
analyzing, at the apparatus in response to receiving the request for positioning model data, a digital twin to determine a plurality of synthetic signal measurements corresponding to a combination of transmitter location and receiver location;
grouping, at the apparatus, the plurality of synthetic signal measurements into at least one synthetic signal measurement cluster;
determining, at the apparatus, clustered synthetic signal measurement information corresponding to each of the at least one synthetic signal measurement cluster; and
transmitting, from the apparatus to the requesting device for each of the at least one synthetic signal measurement cluster, the clustered synthetic signal measurement information and an indication of the receiver location.

Clause 30. The method of claim 29, wherein grouping the plurality of synthetic signal measurements comprises grouping the plurality of synthetic signal measurements based on at least one cluster parameter received in the request for positioning model data.

Clause 31. The method of claim 30, wherein the at least one cluster parameter comprises at least one of a number of clusters to be determined, a delay spread per cluster, and a measurement threshold for each of the plurality of synthetic signal measurements.

Clause 32. The method of claim 29, wherein determining the clustered synthetic signal measurement information comprises determining the clustered synthetic signal measurement information based on at least one path characterization parameter received in the request for positioning model data.

Clause 33. The method of claim 32, wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 34. The method of claim 29, wherein analyzing the digital twin comprises analyzing the digital twin based on at least one ray tracing setting received in the request for positioning model data.

Clause 35. The method of claim 29, further comprising transmitting, from the apparatus, a capability message indicating at least one supported capability for determining the clustered synthetic signal measurement information.

Clause 36. The method of claim 29, further comprising transmitting, from the apparatus to the requesting device, an indication that the clustered synthetic signal measurement information includes synthetic, digital-twin-based measurement information.

Clause 37. An apparatus comprising:
at least one transceiver;
at least one memory; and
at least one processor, communicatively coupled to the at least one transceiver and the at least one memory, configured to:
   receive, via the at least one transceiver from a requesting device, a request for positioning model data;
   analyze, in response to receiving the request for positioning model data, a digital twin to determine a plurality of synthetic signal measurements corresponding to a combination of transmitter location and receiver location;
   group the plurality of synthetic signal measurements into at least one synthetic signal measurement cluster;
   determine clustered synthetic signal measurement information corresponding to each of the at least one synthetic signal measurement cluster; and
   transmit, via the at least one transceiver to the requesting device for each of the at least one synthetic signal measurement cluster, the clustered synthetic signal measurement information and an indication of the receiver location.

Clause 38. The apparatus of claim 37, wherein the at least one processor is configured to group the plurality of synthetic signal measurements based on at least one cluster parameter received in the request for positioning model data.

Clause 39. The apparatus of claim 38, wherein the at least one cluster parameter comprises at least one of a number of clusters to be determined, a delay spread per cluster, and a measurement threshold for each of the plurality of synthetic signal measurements.

Clause 40. The apparatus of claim 37, wherein the at least one processor is configured to determine the clustered synthetic signal measurement information based on at least one path characterization parameter received in the request for positioning model data.

Clause 41. The apparatus of claim 40, wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 42. The apparatus of claim 37, wherein the at least one processor is configured to analyze the digital twin based on at least one ray tracing setting received in the request for positioning model data.

Clause 43. The apparatus of claim 37, wherein the at least one processor is configured to transmit, via the at least one transceiver, a capability message indicating at least one supported capability for determining the clustered synthetic signal measurement information.

Clause 44. The apparatus of claim 37, wherein the at least one processor is configured to transmit, via the at least one transceiver to the requesting device, an indication that the clustered synthetic signal measurement information includes synthetic, digital-twin-based measurement information.

Clause 45. An apparatus comprising:
means for receiving, from a requesting device, a request for positioning model data;
means for analyzing, in response to receiving the request for positioning model data, a digital twin to determine a plurality of synthetic signal measurements corresponding to a combination of transmitter location and receiver location;
means for grouping the plurality of synthetic signal measurements into at least one synthetic signal measurement cluster;
means for determining clustered synthetic signal measurement information corresponding to each of the at least one synthetic signal measurement cluster; and
means for transmitting, to the requesting device for each of the at least one synthetic signal measurement cluster, the clustered synthetic signal measurement information and an indication of the receiver location.

Clause 46. The apparatus of claim 45, wherein the means for grouping the plurality of synthetic signal measurements comprise means for grouping the plurality of synthetic signal measurements based on at least one cluster parameter received in the request for positioning model data.

Clause 47. The apparatus of claim 46, wherein the at least one cluster parameter comprises at least one of a number of clusters to be determined, a delay spread per cluster, and a measurement threshold for each of the plurality of synthetic signal measurements.

Clause 48. The apparatus of claim 45, wherein the means for determining the clustered synthetic signal measurement information comprise means for determining the clustered synthetic signal measurement information based on at least one path characterization parameter received in the request for positioning model data.

Clause 49. The apparatus of claim 48, wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 50. The apparatus of claim 45, wherein the means for analyzing the digital twin comprise means for analyzing the digital twin based on at least one ray tracing setting received in the request for positioning model data.

Clause 51. The apparatus of claim 45, further comprising means for transmitting a capability message indicating at least one supported capability for determining the clustered synthetic signal measurement information.

Clause 52. The apparatus of claim 45, further comprising means for transmitting, to the requesting device, an indication that the clustered synthetic signal measurement information includes synthetic, digital-twin-based measurement information.

Clause 53. A non-transitory, processor-readable storage medium comprising processor-readable instructions to cause at least one processor of an apparatus to:
receive, from a requesting device, a request for positioning model data;
analyze, in response to receiving the request for positioning model data, a digital twin to determine a plurality of synthetic signal measurements corresponding to a combination of transmitter location and receiver location;
group the plurality of synthetic signal measurements into at least one synthetic signal measurement cluster;
determine clustered synthetic signal measurement information corresponding to each of the at least one synthetic signal measurement cluster; and
transmit, to the requesting device for each of the at least one synthetic signal measurement cluster, the clustered synthetic signal measurement information and an indication of the receiver location.

Clause 54. The non-transitory, processor-readable storage medium of claim 53, wherein the processor-readable instructions to cause the at least one processor to group the plurality of synthetic signal measurements comprise processor-readable instructions to cause the at least one processor to group the plurality of synthetic signal measurements based on at least one cluster parameter received in the request for positioning model data.

Clause 55. The non-transitory, processor-readable storage medium of claim 54, wherein the at least one cluster parameter comprises at least one of a number of clusters to be determined, a delay spread per cluster, and a measurement threshold for each of the plurality of synthetic signal measurements.

Clause 56. The non-transitory, processor-readable storage medium of claim 53, wherein the processor-readable instructions to cause the at least one processor to determine the clustered synthetic signal measurement information comprise processor-readable instructions to cause the at least one processor to determine the clustered synthetic signal measurement information based on at least one path characterization parameter received in the request for positioning model data.

Clause 57. The non-transitory, processor-readable storage medium of claim 56, wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

Clause 58. The non-transitory, processor-readable storage medium of claim 53, wherein the processor-readable instructions to cause the at least one processor to analyze the digital twin comprise processor-readable instructions to cause the at least one processor to analyze the digital twin based on at least one ray tracing setting received in the request for positioning model data.

Clause 59. The non-transitory, processor-readable storage medium of claim 53, further comprising processor-readable instructions to cause the at least one processor to transmit a capability message indicating at least one supported capability for determining the clustered synthetic signal measurement information.

Clause 60. The non-transitory, processor-readable storage medium of claim 53, further comprising processor-readable instructions to cause the at least one processor to transmit, to the requesting device, an indication that the clustered synthetic signal measurement information includes synthetic, digital-twin-based measurement information.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method, of obtaining and using synthetic mobile device positioning model data, comprising:
transmitting, from a requesting device to an apparatus configured to implement a digital twin function, a positioning model data request indicating at least one characterization parameter for at least one of determining positioning model data and reporting the positioning model data; and
receiving, at the requesting device from the apparatus, positioning model data indicating a plurality of reception locations and, for each of the plurality of reception locations, a plurality of sets of clustered synthetic signal information.

2. The method of claim 1, wherein the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements.

3. The method of claim 2, wherein the positioning model data request indicates the at least one cluster parameter, and wherein the at least one cluster parameter comprises at least one of a number of clusters to be determined, a delay spread per cluster, and a measurement threshold for each of the plurality of synthetic signal measurements.

4. The method of claim 2, wherein the positioning model data request indicates the at least one path characterization parameter, and wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

5. The method of claim 1, further comprising receiving, at the requesting device from the apparatus, a capability message indicating at least one supported capability for determining the clustered synthetic signal measurement information, wherein content of the positioning model data request is based on the at least one supported capability for determining the clustered synthetic signal measurement information indicated by the capability message.

6. The method of claim 1, wherein the method includes training a mobile device positioning model based on the positioning model data, the method further comprising:
receiving an indication that the plurality of sets of clustered synthetic signal information include synthetic, digital-twin-based measurements;
receiving over-the-air measurements; and
discounting at least some of the synthetic, digital-twin-based measurements relative to corresponding ones of the over-the-air measurements for training the mobile device positioning model.

7. The method of claim 1, further comprising, based on the positioning model data, at least one of training a mobile device positioning model, validating an accuracy of the mobile device positioning model, and monitoring the accuracy of the mobile device positioning model.

8. A positioning model entity comprising:
at least one transceiver;
at least one memory; and
at least one processor, communicatively coupled to the at least one transceiver and the at least one memory, configured to:
transmit, via the at least one transceiver to an apparatus configured to implement a digital twin function, a positioning model data request indicating at least one characterization parameter for at least one of determining positioning model data and reporting the positioning model data; and
receive, via the at least one transceiver from the apparatus, positioning model data indicating a plurality of reception locations and, for each of the plurality of reception locations, a plurality of sets of clustered synthetic signal information.

9. The positioning model entity of claim 8, wherein the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements.

10. The positioning model entity of claim 9, wherein the positioning model data request indicates the at least one cluster parameter, and wherein the at least one cluster parameter comprises at least one of a number of clusters to be determined, a delay spread per cluster, and a measurement threshold for each of the plurality of synthetic signal measurements.

11. The positioning model entity of claim 9, wherein the positioning model data request indicates the at least one path characterization parameter, and wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

12. The positioning model entity of claim 8, wherein the at least one processor is configured to receive, via the at least one transceiver from the apparatus, a capability message indicating at least one supported capability for determining the clustered synthetic signal measurement information, wherein the at least one processor is configured to base content of the positioning model data request on the at least one supported capability for determining the clustered synthetic signal measurement information indicated by the capability message.

13. The positioning model entity of claim 8, wherein the at least one processor is configured to train a mobile device positioning model based on the positioning model data, and the at least one processor is configured to:
receive, via the at least one transceiver, an indication that the plurality of sets of clustered synthetic signal information include synthetic, digital-twin-based measurements;
receive, via the at least one transceiver, over-the-air measurements; and
discount at least some of the synthetic, digital-twin-based measurements relative to corresponding ones of the over-the-air measurements to train the mobile device positioning model.

14. The positioning model entity of claim 8, wherein the at least one processor is configured to, based on the positioning model data, at least one of train a mobile device positioning model, validate an accuracy of the mobile device positioning model, and monitor the accuracy of the mobile device positioning model.

15. A positioning model entity comprising:
means for transmitting, to an apparatus configured to implement a digital twin function, a positioning model data request indicating at least one characterization parameter for at least one of determining positioning model data and reporting the positioning model data; and
means for receiving, from the apparatus, positioning model data indicating a plurality of reception locations and, for each of the plurality of reception locations, a plurality of sets of clustered synthetic signal information.

16. The positioning model entity of claim 15, wherein the at least one characterization parameter includes at least one of (1) at least one cluster parameter for the digital twin function to use to determine at least one synthetic signal measurement cluster of a plurality of synthetic signal measurements corresponding to a transmit location and a reception location, (2) at least one path characterization parameter for the digital twin function to use to determine clustered synthetic signal measurement information corresponding to each of the at least one synthetic signal measurement cluster, and (3) at least one ray tracing setting for the digital twin function to use to analyze a digital twin to determine the plurality of synthetic signal measurements.

17. The positioning model entity of claim 16, wherein the positioning model data request indicates the at least one cluster parameter, and wherein the at least one cluster parameter comprises at least one of a number of clusters to be determined, a delay spread per cluster, and a measurement threshold for each of the plurality of synthetic signal measurements.

18. The positioning model entity of claim 16, wherein the positioning model data request indicates the at least one path characterization parameter, and wherein the at least one path characterization parameter indicates for the clustered synthetic signal measurement information to be determined, for each of the at least one synthetic signal measurement cluster, from one of a median time of arrival synthetic signal measurement, a highest received power synthetic signal measurement, an average time of arrival synthetic signal measurement, and an earliest time of arrival synthetic signal measurement.

19. The positioning model entity of claim 15, further comprising means for receiving, from the apparatus, a capability message indicating at least one supported capability for determining the clustered synthetic signal measurement information, wherein the means for transmitting the positioning model data request include means for determining content of the positioning model data request based on the at least one supported capability for determining the clustered synthetic signal measurement information indicated by the capability message.

20. The positioning model entity of claim 15, wherein the positioning model entity includes the means for training a mobile device positioning model based on the positioning model data, the positioning model entity further comprising:
means for receiving an indication that the plurality of sets of clustered synthetic signal information include synthetic, digital-twin-based measurements;
means for receiving over-the-air measurements; and
means for discounting at least some of the synthetic, digital-twin-based measurements relative to corresponding ones of the over-the-air measurements for training the mobile device positioning model.
